(19) United States
(12) Patent Application Publication
(10) Pub. No.: US 2005/0271887 A1
(43) Pub. Date: Dec. 8, 2005

(54) Extrusion process with polyamides

(76) Inventors: Ralph Ulrich, Ratingen (DE); Wolfram Littek, Solingen (DE); Helmut Schulte, Krefeld (DE); Dietbert Huffmann, Wuppertal (DE)

Correspondence Address: LANXESS CORPORATION, 111 RIDC PARK WEST DRIVE, PITTSBURGH, PA, 15275-1112, US

(21) Appl. No.: 11/133,537

(22) Filed: May 20, 2005

(30) Foreign Application Priority Data
May 21, 2004 (DE) 1020040250014

(51) Int. Cl. B29C 47/06; B32B 27/34; B32B 27/18

(52) U.S. Cl. 428/474.4; 264/171.23; 428/323

(57) ABSTRACT

The present invention relates to a process for coating substrates with polyamides by the use of nanoscale particles with coating rates of at least 250 m/min, as a result of which “edge waving” and “neck-in” are prevented.

The present invention relates to an extrusion process for coating substrates with polyamides by the use of nanoscale particles with coating rates of at least 250 m/min, as a result of which “edge waving” and “neck-in” are prevented.

Extrusion coating allows a multitude of properties of packagings to be positively influenced. Coating with thermoplastic polymer allows, for example, improvements in areas such as mechanical properties, barrier action against water, gases, grease, aromas, etc., printability and optical properties to be achieved. It is likewise possible to improve the sealability.

Typical examples of products which are prepared via extrusion coating are, for example, the coating of paper with polyethylene (PE) or, for example, thick coatings (25-100 g/m²) for sugar packagings, or else coatings of cardboard with PE and/or aluminium, for example for milk packagings.

Currently the quantitatively most important application of extrusion coating is the coating of paper or cardboard with polyethylene. In this process, mainly low-density polyethylenes (LDPE) which have been produced via a high-pressure process are used.

The addition to polyethylenes, polyamides are also increasingly finding use in extrusion coating, usually in combination with polyethylenes and adhesion promoter products in coextrusion coating.

Frequently, what is known as “edge waving” is observed in extrusion coating with polyamides as a periodically repeating variation in the melt web width. The outer edge of the melt web exiting from the coating die does not run on one line in the draw-off direction. Edge waving usually occurs only in single-layer coating and can be substantially suppressed by skilful selection of suitable products in the course of coextrusion coating. Inhomogeneous temperature distributions of the extruder, unoptimized screw geometries and inadequate granule quality can enhance the abovementioned effects and lead to tearing of the melt web over the entire width, especially at high draw-off rate.

Multilayer composite films comprising nylon-6 components find use mainly as a packaging film for foods, industrial products of various types and medical instruments. For germ-free packagings, sterilization is undertaken with steam, ethylene oxide or gamma rays.

Conventional nylon-6 types such as Durethan® B31 F or Durethan® B35 F tend, particularly in monoextrusion coating, to edge waving and neck-in (NI) at high processing speeds. NI refers to the lateral constriction of the melt web after leaving the die.

The literature specifies the highest coating rate with nylon-6 onto paper or cardboard as being about 250 m/min (TAPPI International Coextrusion Seminar, 6-8 Jun. 1978, Amsterdam, E. Laiho, D. Michael; TAPPI European PLACE Conference, Rome, May 2003, Schwarz, Mahlke).

It is an object of the invention to find an extrusion process for coating substrates with polyamides which permits higher coating rates and at the same time prevents edge waving and neck-in. The object of the invention is achieved by combining the standard process for extrusion coating with a polyamide modified by nanoscale particles and the coating rate being at least 250 m/min.

The present invention therefore provides an extrusion process for coating substrates with polyamides, characterized in that polyamides comprising nanoscale particles are applied to the substrates in the mono- and/or coextrusion coating operation with coating rates of at least 250 m/min, preferably 250 to 350 m/min.

The extrudates obtainable by the process according to the invention all exhibit positive properties, as are known from the prior art on the use of nanoscale particles, for example higher tensile strain at break and fracture resistance, finer spherolitic structure, lower light scattering and an increase in the barrier action against gases.

Surprisingly, though, the use of nanoscale particles in polyamides in the extrusion coating additionally reduces the neck-in (NI). A reduction in the NI means an effective increase in the coating width. As the results in the context of the present invention show, the NI in polyamides comprising nanoscale particles is also invariable with respect to variations in the coating rate, while the NI in the case of conventional polyamide increases with the coating rate. (Schwarz, Mahlke, TAPPI European PLACE Conference, Rome, May 2003).

In a preferred embodiment, polyamides comprising nanoscale particles are extruded together with polyalkylenes, more preferably with polyethylene (PE). For instance, it is possible using polyamide comprising nanoscale particles together with PE and adhesion promoters in coextrusion coating onto paper to attain coating rates of 300 m/min without exhibiting edge waving or tears of the melt web (see Table 1).

In the single-layer coating, it is possible with polyamide comprising nanoscale particles at a constant coating weight of 30 g/m² to achieve a max. coating rate of 250 m/min, compared to max. 150 m/min in the case of conventional nylon-6.

Nanoscale fillers to be used in the polyamide in accordance with the invention are particles whose length measurement in a selectable direction is less than 1 micrometre. The average particle size is determined, for example, by visually assessing transmission electron micrographs of ultra thin layers of the corresponding mouldings. If the particles are strongly anisotropic, the particle size refers to the measurements of the smallest axis occurring. For instance, in the case of platelet-shaped particles, the particle size refers to the platelet thickness. One review of nanoscale fillers to be used in accordance with the invention is given, for example, in Nanocomposites-auf dem Weg zur Anwendung, KU Kunstoffe, 10, 91, 2001, 178-190.

The nanoscale fillers or particles to be used in accordance with the invention may be selected from the group of the oxide, oxides hydrates or metals or semimetals. Preference is given in accordance with the invention to using oxides or oxide hydrates of an element from the group of boron, aluminium, gallium, indium, silicon, tin, titanium, zirconium, zinc, yttrium or iron.

In addition, the nanoscale particles used may also be dendritic or highly branched compounds. These may be selected, for example, from the group of the polyethylenimines, polypropylenimines, polyamides, polyester amides, polyesters or polyethers.

According to the invention, preference is given to using nanoscale particles from the group of the sheet silicate. These may stem from the group of the phyllosilicates such as magnesium silicate or aluminium silicate, and also montmorillonite, saponite, beidellite, nontronite, hectorite, stevensite, vermiculite, halloysite or their synthetic analogues.

The nanoscale particles may be added to the reaction mixture at the start of the polymerization. However, it is also possible to modify the already existing polymer with nanoscale particles in a second process step. It is possible to incorporate from 0.01 to 10% by weight, preferably 0.01-5.0% by weight, more preferably 0.1-3% by weight, of nanoscale particles into the polymer.

The substrate to be coated is not restricted to paper or cardboard, but also includes further cellulose-based materials, for example cellophane, metals, for example aluminium foil, and other polymer substrates, for example PET, polyethylene, films or biaxially oriented polypropylene or polyamides.

Polyamides to be used in accordance with the invention are known aliphatic or aromatic or semiaromatic homopolyamides or copolyamides or mixtures of a plurality of polyamides or mixtures of polyamides with copolyamides and/or further polymers. Preference is given to using, for example and each independently, PA6, PA66, PA 11, PA12, PA46, PA610, polyamide 6, polyamide 10, polyamide 12, polyamide 66, polyamide 610, polyamide 6I, polyamide 612, polyamide 6/12, polyamide 6/66, polyamide 6I/6T, polyamide MXD6, polyamide 6/6I, polyamide 6/6T, polyamide 6/IPDI and copolymers and polymer mixtures of these groups.

Particular preference is given to using PA6 or PA66 or a copolyamide composed of caprolactam units and units derived from hexamethylenediamine and isophthalic acid or hexamethylenediamine and terephthalic acid or hexamethylenediamine and adipic acid. Preference is given to copolyamide fractions of 0-50% by weight, particular preference to copolyamide fractions between 0-25% by weight, most preferably 0-15% by weight.

The present invention also provides the films, coatings, moulding compositions or hollow bodies which are obtained by the extrusion process according to the invention by means of nanoscale particles containing polyamides, and also packagings of all types which are obtained by folding or sealing the nanoscale particles containing polyamides, or polymer mixtures comprising these polyamides with other polymers, for example with PE.

Preferred, particularly preferred or very particularly preferred embodiments are those which make use of the parameters, compounds, definitions and explanations specified under preferred, particularly preferred or very particularly preferred.

However, the definitions, parameters, compounds and illustrations given above, in general or within areas of preference, may also be combined with one another, i.e. between the particular areas and areas of preference.

The coatings, films or hollow bodies produced by the extrusion process according to the invention may consist only of one polyamide layer or have a multilayer structure. In the case of the multilayer structure, the further layers may consist, for example, of polyolefins, for example polyethylene, or polyethylene copolymers, for example copolymers of ethylene and acrylic acid or methacrylic acid, or barrier polymers, for example polyvinylidene chloride, or copolymers of ethylene and vinyl alcohol, or of further polyamide layers.

The starting polyamides to be used for the extrusion process according to the invention may be produced in a known manner in a continuous or in a batchwise process. A batchwise process may, for example, be polymerization in an autoclave. A continuous process may, for example, be polymerization in what is known as a VK tube. Preference is given to effecting the preparation by a continuous process. To achieve high molar masses, as may be required for certain applications in film extrusion or in extrusion coating, the polymerization in the melt may be followed by a postcondensation in solid phase. The nanoscale particles may be added in any process step or in several process steps or be compounded in in a subsequent step.

The moulding compositions, mouldings, hollow bodies or films to be produced by the extrusion process according to the invention may be processed further or reshaped before their ultimate use. They may be used, for example, for packaging purposes. Films or moulding compositions to be produced in accordance with the invention may be used, for example, to package food or drink, such as milk, fruit juices, meat and meat products, sausage, cheese, drinks, and many others. The inventive films or moulding compositions may also be used, for example, to package cosmetics, for example sun protection creams, or chemicals, for example crop protection compositions.

The properties of the polyamides which comprise nanoscale particles and are to be extruded can be improved by addition of elastomers, for example with regard to creasing fracture (DE-A 10 23 78 20). The multitude of possible combinations enables a very large number of products having very different properties.

As already described above, the polyamides comprising nanoscale particles to be used may also be used in a mixture with other polyamides and/or further polymers.

Such polymers are described, for example, in Houben-Weyl, Methoden der organischen Chemie, Vol. 14.1 (Georg-Thieme-Verlag), Stuttgart, 1961, pages 392 to 406, and in the Monograph of C. B. Bucknall, “Toughened Plastics” (Applied Science Publishers, London, 1977).

It will be understood that the specification and examples are illustrative but not limitative of the present invention and that other embodiments within the spirit and scope of the invention will suggest themselves to those skilled in the art.

### EXAMPLES

Test Methods:

Visual Observation of the Coating Process

Materials Used:

Durethan® KU2-2601, commercially available polyamide from LANXESS Deutschland GmbH
Durethan® B35 FKA, commercially available nylon-6 from LANXESS Deutschland GmbH
Bynel® 4288, commercially available from DuPont
Novex® 19N430, commercially available LDPE from BP

The experiments were carried out on the ER-WE-PA Davis-Standard extrusion coating line with an 800 mm-wide coating die from EC Erdölchemie in Cologne.

### Comparative Example 1

Polyamide: 25 g/m² of B35 FKA
Adhesion promoter: 5 g/m² of Bynel® 4288
Polyethylene: 15 g/m² of Novex® 19N430
Coating rate: 200 m/min

### Comparative Example 2

Polyamide: 15 g/m² of B35 FKA
Adhesion promoter: 5 g/m² of Bynel® 4288
Polyethylene: 15 g/m² of Novex® 19N430
Coating rate: 300 m/min

### Example 1

Polyamide: 15 g/m² of B35 FKA
Adhesion promoter: 5 g/m² of Bynel® 4288
Polyethylene: 15 g/m² of Novex® 19N430
Coating rate: 200 m/min

### Example 2

Polyamide: 15 g/m² of KU2-2601
Adhesion promoter: 5 g/m² of Bynel® 4288
Polyethylene: 15 g/m² of Novex® 19N430
Coating rate: 300 m/min

### Comparative Example 3

### Single-Layer Coating

Polyamide: 30 g/m² of Durethan® B35 FKA
Coating rate: 150 m/min

### Example 3

### KU2-2601 Single-Layer Coating

Polyamide: 30 g/m² of KU2-2601
Coating rate: 250 m/min

The results of the coextrusion experiments are summarized in Table 1.

TABLE 1

| | | | Processing |
|---|---|---|---|
| Experiment | Polyamide type | Processing rate | performance |
| Comparative | B35 FKA | 200 m/min | 0 |
| Example 1 | | | |
| Comparative | B35 FKA | 300 m/min | − |
| Example 2 | | | |
| Example 1 | KU2-2601 | 200 m/min | + |
| Example 2 | KU2-2601 | 300 m/min | + |

+: excellent processing performance
0: processing performance still just acceptable
−: poor processing performance

The results of the single-layer coatings are summarized in Table 2.

TABLE 2

| Experiment | Polyamide type | Processing rate | Edge stability |
|---|---|---|---|
| Comparative | B35 FKA | 150 m/min | 0 |
| Example 3 | | | |
| Example 3 | KU2-2601 | 250 m/min | + |

+: excellent processing performance
0: processing performance still just acceptable
−: unacceptable processing performance

1. An extrusion process for coating substrates with polyamides wherein polyamides comprising nanoscale particles are applied to the substrates in the mono- and/or coextrusion coating operation with coating rates of at least 250 m/min.

2. A process according to claim 1 wherein nylon-6 comprising nanoscale particles is used.

3. A process according to claim 1 wherein the polyamide comprising nanoscale particles is mixed with other polyamides and/or copolyamides and/or further polymers.

4. A process according to claim 3 wherein polyethylene is used as a further polymer.

5. A method of use of polyamides comprising nanoscale particles for application to substrates in mono- and/or coextrusion coating operations with coating rates of at least 250 m/min.

6. A moulding compositions, mouldings, hollow bodies or films obtained by extrusion coating of polyamides comprising nanoscale particles with coating rates of at least 250 m/min.

7. A method of use use of the moulding compositions or films obtained according to claim 6 for packaging foods, cosmetics or chemicals.
